(19) United States
(12) Patent Application Publication
(10) Pub. No.: US 2020/0073679 A1
(43) Pub. Date: Mar. 5, 2020

(54) OBJECTIVELY MEASURING AND CHANGING VISUAL AESTHETICS OF A GRAPHICAL USER INTERFACE OF AN APPLICATION

(71) Applicant: CA, Inc., New York, NY (US)

(72) Inventors: Vallinayagam Pitchaimani, Chennai (IN); Sri Harsha Yayi, Hyderabad (IN); STV Krishna Kanth, Hyderabad (IN); Balram Reddy Kakani, Hyderabad (IN); Nageswara Rao Yeluri, Hyderabad (IN)

(73) Assignee: CA, Inc., New York, NY (US)

(21) Appl. No.: 16/114,680

(22) Filed: Aug. 28, 2018

(51) Int. Cl. G06F 9/451; G06F 8/38; G06F 3/0481; G06F 3/0484; H04L 29/08

(52) U.S. Cl. CPC G06F 9/451; G06F 8/38; H04L 67/22; G06F 3/04842; G06F 3/0481

(57) ABSTRACT

Methods and visual analysis (VA) engines for dynamically modifying layout of user-selectable elements of a graphical user interface (GUI) of an application. An VA engine of a hardware computer determines a usage pattern of a plurality of user-selectable elements of a GUI of an application. The VA engine determines a number of user-selectable elements relative to a total number of the plurality of user-selectable elements that are selected more frequently than other user-selectable elements based on the usage patterns. The VA engine selects a visual aesthetic pattern from among a set of visual aesthetic patterns based on the number of user-selectable elements. The VA engine dynamically modifies layout, during runtime of the application, of the user-selectable elements of the GUI based on the visual aesthetic pattern that was selected. The VA engine displays the graphical user interface with the modified layout of the user-selectable elements of the graphical user interface.

### FIELD

Some embodiments described herein relate to application user interfaces, and in particular to dynamically modifying layout of graphical user interfaces based on visual aesthetics.

### BACKGROUND

User interface design for applications is the design of user interfaces for machines and software-based applications, such as applications for computers, mobile devices, tablets, and the like. The design tends to focus on anticipating what users might want or need to do and provide interface elements that are easy to access, understand, and use.

Traditionally, the user interfaces of an application, and thus how users experience an application and ease of use, are designed by a few designers of a design team. For many designers, the designer is on a deadline and thus focuses on the series of screens, pages, and visual elements a user sees and uses to interact with the application.

The drawbacks with the user interface design include the possibility of bias on the design based on the designers, the user interface being static until it is changed in an application update, and no ability to change the user interface between application updates.

### SUMMARY

Some embodiments are directed to a method in a visual analysis engine of a networked hardware device for dynamically modifying a graphical user interface of an application. The graphical user interface has a plurality of user-selectable elements. The method includes determining a number of user-selectable elements relative to a total number of the plurality of user-selectable elements that are selected more frequently than other user-selectable elements based on tracking user selections among the user-selectable elements over a period of time. The method further includes selecting a visual aesthetic pattern from among a set of visual aesthetic patterns based on the number of user-selectable elements. The method includes dynamically modifying layout, during runtime of the application, of the user-selectable elements of the graphical user interface based on the visual aesthetic pattern that was selected and displaying the graphical user interface with the modified layout of the user-selectable elements of the graphical user interface.

The method may further include receiving a change in a display parameter of a display device that is displaying the graphical user interface. A current layout of user-selectable elements of the graphical user interface is obtained. A usage pattern based on tracking user selections among the user-selectable elements of the current layout is obtained. A new layout is created of the user-selectable elements of the graphical user interface by adjusting size and/or location of the user-selectable elements of the current layout based on the usage pattern for the current layout and the visual aesthetic pattern that was selected. The new layout of the user-selectable elements of the graphical user interface is displayed.

The method may further include determining locations of the number of user-selectable elements. For each of the number of user-selectable elements, the location of the user-selectable element is compared to a characteristic location of each of the visual aesthetic patterns. A distance between the location of the user-selectable element to the characteristic location of each of the visual aesthetic patterns is determined. The visual aesthetic patterns that has a lowest total distance between the locations of the number of user-selectable elements and the characteristic location is determined and selected.

The method may further include receiving usage patterns of user selections among the plurality of user-selectable elements during a beta testing execution phase of the application. The number of user-selectable elements relative to the total number of the plurality of user-selectable elements is determined based on the usage patterns.

Corresponding visual analysis engines of a hardware computer are disclosed. In some embodiments, the visual analysis engine includes a processor and a memory coupled to the processor, wherein the memory stores computer program instructions that are executed by the processor to perform operations that include determining a usage pattern of a plurality of user-selectable elements of a graphical user interface of an application. The operations further include determining a number of user-selectable elements relative to a total number of the plurality of user-selectable elements that are selected more frequently than other user-selectable elements based on the usage patterns. The operations further include selecting a visual aesthetic pattern from among a set of visual aesthetic patterns based on the number of user-selectable elements. The operations further include dynamically modifying layout, during runtime of the application, of the user-selectable elements of the graphical user interface based on the visual aesthetic pattern that was selected. The operations further include displaying the graphical user interface with the modified layout of the user-selectable elements of the graphical user interface.

The operations of the visual analysis engine may further include determining that a display view of a display device that is displaying the graphical user interface is a desktop view. These operations further include dynamically modifying layout of the user-selectable elements of the graphical user interface based on the visual aesthetic pattern that was selected and the desktop view. These operations further include receiving an indication that the graphical user interface is being displayed on a display of a second display device having a second display view that is a mobile device view. These operations further include dynamically modifying layout of the user-selectable elements of the graphical user interface based on the visual aesthetic pattern that was selected and the mobile device view.

The operations of the visual analysis engine may further include determining that a display view of a display device that is displaying the graphical user interface is a mobile device view. These operations further include dynamically modifying layout of the user-selectable elements of the graphical user interface based on the visual aesthetic pattern that was selected and the mobile device view. These operations further include receiving an indication that the graphical user interface is being displayed on a display of a second display device having a second display view that is a desktop view. These operations further include dynamically modifying layout of the user-selectable elements of the graphical user interface based on the visual aesthetic pattern that was selected and the desktop view.

It is noted that aspects of the inventive concepts described with respect to one embodiment may be incorporated in different embodiments although not specifically described relative thereto. That is, all embodiments or features of any embodiments can be combined in any way and/or combination. These and other objects or aspects of the present inventive concepts are explained in detail in the specification set forth below.

Advantages that may be provided by various of the concepts disclosed herein include dynamically modifying layout of user-selectable elements of a GUI of an application during runtime without having to update the application. The layout can be modified based on a change in display view, a change in one or more display parameters, the device that is running the application, usage patterns determined over periods of time, user input, and on user feedback. The advantages further allow the layout to be dynamically modified based on changing styles over time based on the usage patterns and user feedback without requiring the application to be updated. This results in a better user experience, which can lead to increased use of an application compared to other applications that have fixed layouts that cannot be changed between application updates.

Other methods, devices, and computer program products, and advantages will be or become apparent to one with skill in the art upon review of the following drawings and detailed description. It is intended that all such additional systems, methods, or computer program products and advantages be included within this description, be within the scope of the present inventive concepts, and be protected by the accompanying claims.

### BRIEF DESCRIPTION OF THE DRAWINGS

The accompanying drawings are included to provide a further understanding of the disclosure and are incorporated in and constitute a part of this application. In the drawings:

FIG. 1 is a block diagram illustrating an exemplary environment of a visual analysis (VA) engine communicating with monitoring systems and a topology service according to some embodiments.

FIG. 2 is an exemplary signaling diagram for illustrating procedures according to an embodiment.

FIG. 3 is a flowchart illustrating operations to determine the number of user-selectable elements according to some embodiments.

FIG. 4 is a block diagram illustrating a rule of 3^{rd} visual aesthetic pattern according to some embodiments.

FIG. 5 is a block diagram illustrating a golden ratio visual aesthetic pattern according to some embodiments.

FIG. 6 is a block diagram illustrating a Fibonacci spiral visual aesthetic pattern according to some embodiments.

FIG. 7 is a flowchart illustrating operations to select a visual aesthetic pattern according to some embodiments.

FIG. 8 is a flowchart illustrating operations to select a visual aesthetic pattern according to some embodiments.

FIG. 9 is a flowchart illustrating operations to select a visual aesthetic pattern based on locations of user-selectable elements according to some embodiments.

FIGS. 10A and 10B are block diagrams illustrating a distance between a user-selectable element and a characteristic location of a visual aesthetic pattern according to some embodiments.

FIG. 11A and 11B are block diagram illustrating a modification in layout of user-selectable elements according to some embodiments.

FIG. 12 is a flowchart illustrating operations to create a new layout of user-selectable elements of a graphical user interface according to some embodiments.

FIG. 13 is a flowchart illustrating operations to recommend a visual aesthetic pattern according to an embodiment.

FIG. 14 is a flowchart illustrating operations to select a visual aesthetic pattern based on the recommendation according to some embodiments.

FIG. 15 is a flowchart illustrating operations to determine a number of user-selectable elements according to some embodiments.

FIG. 16 is a flowchart illustrating operations to determine a usage pattern according to some embodiments.

FIG. 17 is a block diagram illustrating various operations to receive an indication of which user-selectable elements are frequently selected according to some embodiments.

FIG. 18 is a flowchart illustrating operations to select a visual aesthetic pattern according to some embodiments.

FIG. 19 is a flowchart illustrating operations to dynamically modify a layout of user-selectable elements of a graphical user interface based on a change in display view according to some embodiments.

FIGS. 20A and 20B are block diagrams illustrating a dynamically modified layout of user-selectable elements based on a change in display view according to some embodiments.

FIG. 21 is a flowchart illustrating operations to dynamically modify a layout of user-selectable elements of a graphical user interface based on a change in display view according to some embodiments.

FIG. 22 is a block diagram of a hardware computer having a VA engine according to some embodiments

FIG. 23 is a block diagram of components of an application device according to some embodiments.

### DETAILED DESCRIPTION OF EMBODIMENTS

Embodiments of the present inventive concepts now will be described more fully hereinafter with reference to the accompanying drawings. Throughout the drawings, the same reference numbers are used for similar or corresponding elements. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “or” is used nonexclusively to include any and all combinations of one or more of the associated listed items.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” or “including” when used herein, specify the presence of stated features, integers, steps, operations, elements, or components, but do not preclude the presence or addition of one or more other features, integers, steps, operations, elements, components, or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments described herein provide methods or visual analysis (VA) engines for dynamically modifying layout of a graphical user interface of an application where the graphical user interface has a plurality of user-selectable elements. According to some embodiments, a VA engine determines a number of user-selectable elements relative to a total number of the plurality of user-selectable elements that are selected more frequently than other user-selectable elements. The determination may be based on a usage pattern of a plurality of user-selectable elements of a graphical user interface of an application. The VA engine selects a visual aesthetic pattern from among a set of visual aesthetic patterns based on the number of user-selectable elements. The VA engine dynamically modifies layout, during runtime of the application, of the user-selectable elements of the graphical user interface based on the visual aesthetic pattern that was selected. The VA engine displays the graphical user interface with the modified layout of the user-selectable elements of the graphical user interface.

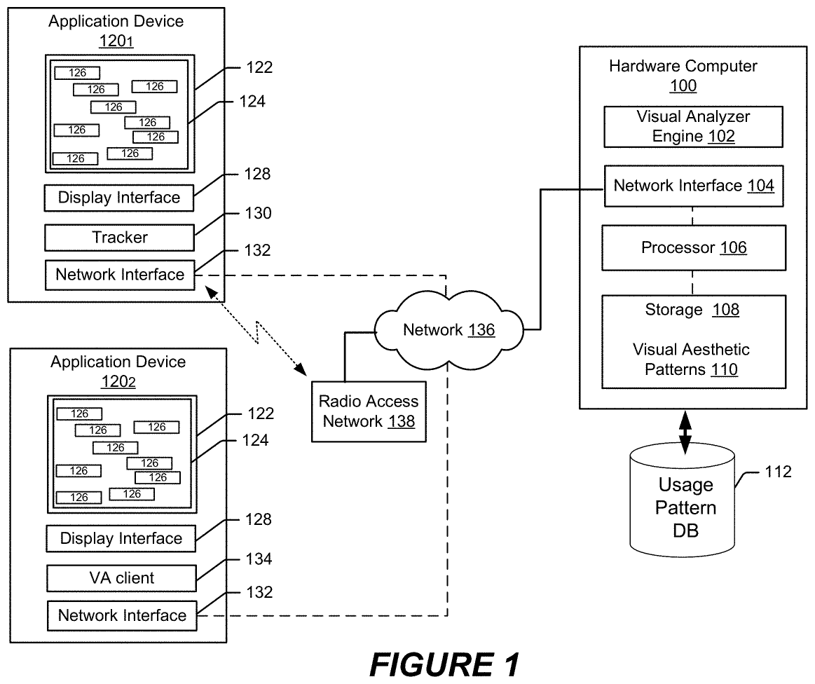

FIG. 1 is a block diagram illustrating an environment for dynamically modifying layout of user-selectable elements of a graphical user interface (GUI) of an application according to an embodiment. As shown, a visual analyzer engine 102 is provided in a hardware computer 100. The hardware computer has a network interface 104, a processor 106, and storage 108. Storage 108 may store visual aesthetic pattern information 110 as described below. Usage patterns of users using GUIs of an application are stored in usage pattern database 112.

The VA engine 102 communications with application devices 120. Application device 120₁ has a display 122 that displays a graphical user interface 124 of an application where the graphical user interface displays user-selectable elements 126, a display interface 128 that controls the display 122, a tracker 130 that tracks user selections of the user-selectable elements 126, and a network interface 132 that transmits messages to the VA engine 102 and receives messages from the VA engine 102 via network 136 or network 136 and radio access network 138.

Network 136 may be a local area network, the Internet, a wide-area network, and the like. Radio access network 138 may be a local wireless network or a wireless mobile communication network.

The tracker 130 may be a separate component, part of the display interface 136, or part of a VA client 132 that is installed on the application device 1202. The application device 120 may be a personal computer, a tablet, a mobile device, or any other device that displays graphical user interfaces of applications.

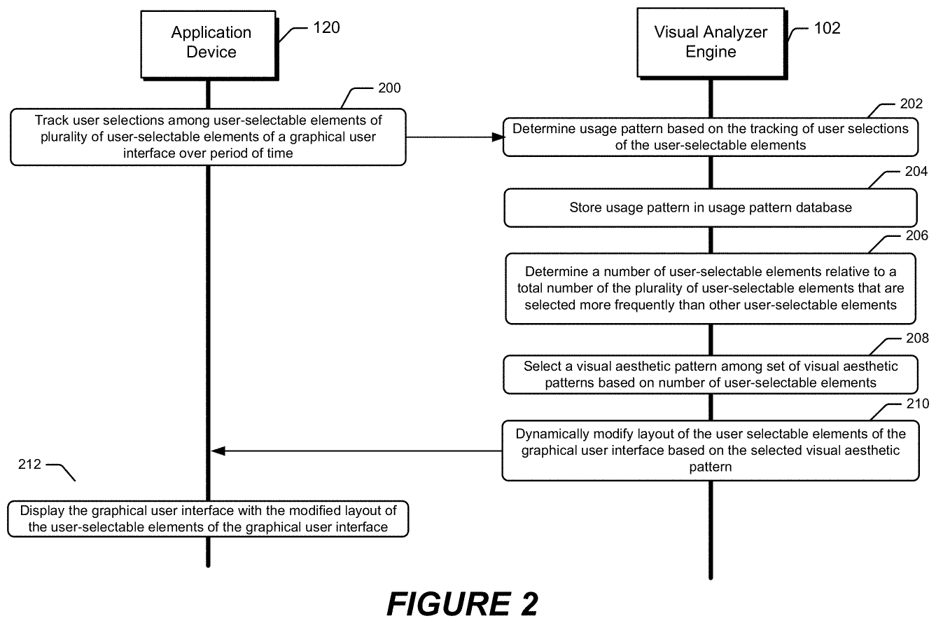

FIG. 2 is a signaling diagram of an exemplary procedure that includes dynamically modifying layout of user-selectable elements 126 of a graphical user interface 128 of an application. The procedure of FIG. 2 involves the VA engine 102 and application device 120.

Initially, at operation 200, user selections among user-selectable elements 126 of graphical user interface 124 displayed on a display 122 of an application device 120 over a period of time are tracked. At operation 202, the VA engine 102 determines a usage pattern based on the tracking of user selections of the user-selectable elements. The usage pattern is stored in usage pattern database 112 at operation 204. Each usage pattern may have information such as an identification of the application, an identification of the graphical user interface 124, an identification of the application device 120, the current layout of the user-selectable elements, the number of user selections of the user-selectable elements that have been selected during the period of time, which user-selectable elements were selected and the time of user selection, the location of a user-selectable element when it was selected, the number of times a user-selectable element was selected, and the like.

The usage pattern database 112 stores multiple usage patterns from multiple trackings of multiple users of an applications. The multiple usage patterns may be compared to identify short-term trends and long-terms trends of user selections of the user-selectable elements.

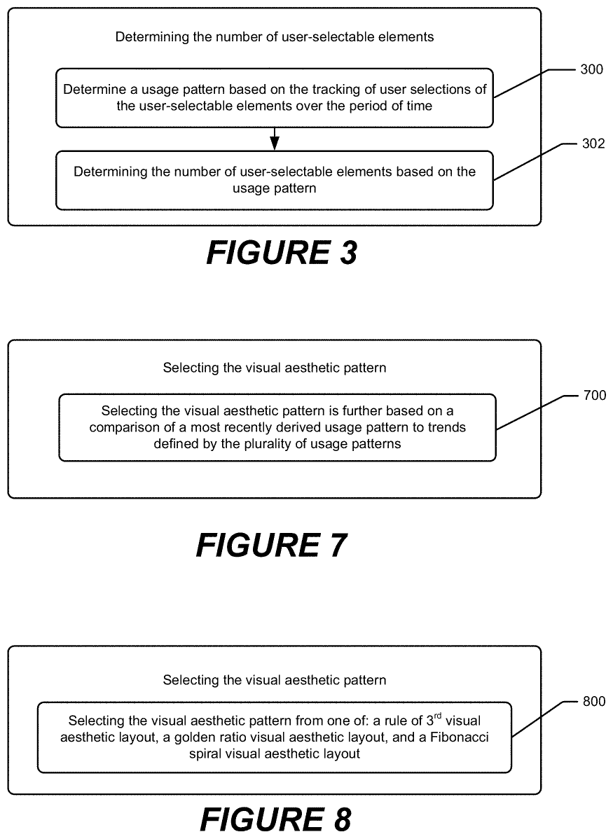

At operation 206, a number of user-selectable elements 126 relative to the total number of user-selectable elements 126 that are selected more frequently than other user-selectable elements is determined. FIG. 3 illustrates an embodiment of determining the number. At operation 600, a usage pattern is determined based on the tracking of user selections of the user-selectable elements 126 over the period of time. At operation 602, the number of user-selectable elements is determined based on the usage pattern.

The number of user-selectable elements may be a pre-defined number, a number based on the usage pattern, a number based on the visual aesthetic pattern selected at operation 208, the average reaction time a user takes to make a selection, etc.

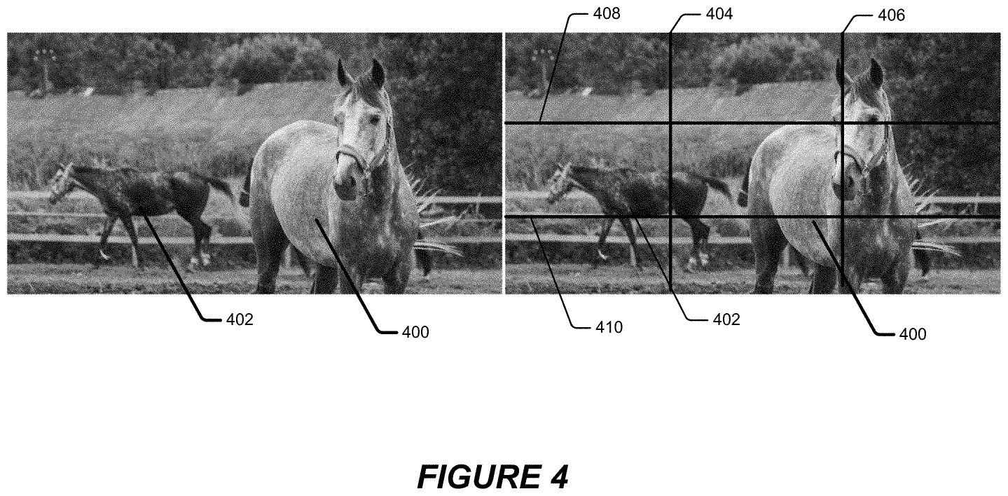

Returning to FIG. 2, at operation 208, a visual aesthetic pattern among a set of visual aesthetic patterns is selected. A visual aesthetic pattern is a pattern of how the more frequently selected user-selectable elements are presented on the graphical user interface of the application such that the more frequently selected user-selectable elements are easier to see and be selected. FIGS. 4 to 6 illustrate examples of visual aesthetic layouts.

Turning to FIG. 4, a rule of thirds visual aesthetic layout is illustrated. The rule of thirds is a process of composing visual images in such a way that an image is divided into nine equal parts by two equally space vertical lines 402, 404 and two equally spaced horizontal lines 406, 408. The frequently selected user-selectable elements 126 are placed along these lines or their intersections. In the example provided, user-selectable elements 400, 402 are images of horses. The head of user-selectable element 400 as shown is located near the intersection of lines 406 and 408 and the body of user-selectable element 400 is along lines 406 and line 410. The user-selectable element 402 is along line 410. In some embodiments, multiple rule of thirds may be used. For example, if a graphical user interface is simulating three dimensions, then there may be a rule of third pattern along at least two of the three dimensions.

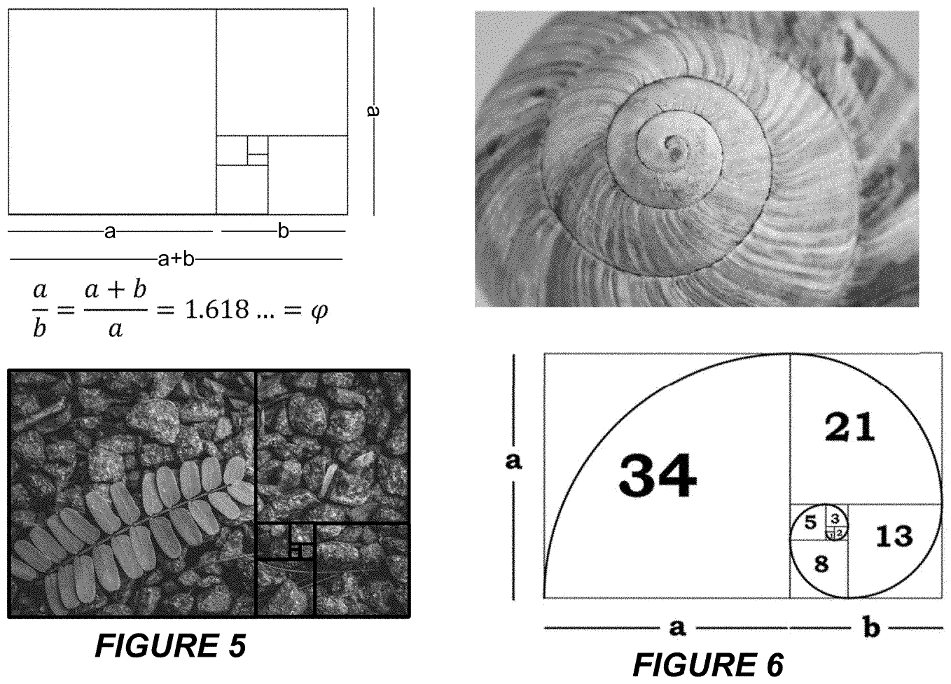

FIG. 5 illustrates a golden ratio visual aesthetic layout. The golden ratio is a mathematical ratio, often found in nature. When used in a layout, the frequently selected user-selectable elements 126 are placed using the golden ratio. In the image shown, a user-selectable element 126 can be placed in one or more of the boxes. Circles that touch all four edges of each of the boxes may be used. Similar to the rule of thirds, lines may be used using the golden ratio of 1.618 . . . . For example, the Google logo uses a golden ratio in the inner and outer “circles” in the G. In some embodiments, multiple golden ratios may be used. For example, if a graphical user interface is simulating three dimensions, then there may be a golden ratio used along at least two of the three dimensions.

FIG. 6 illustrates a Fibonacci spiral visual aesthetic layout. The Fibonacci Spiral is a logarithmic spiral whose growth factor is ϕ, the golden ratio. In other words, the spiral gets wider (or further from its origin) by a factor of ϕ for every quarter turn it makes. The frequently selected user-selectable elements 126 are placed along the spiral. As illustrated, the origin of the Fibonacci spiral is in the middle of the shell. The origin of the Fibonacci spiral may be at any region of the layout. For example, the origin may be at the upper right region, the upper left region, the lower left region, the middle region, etc. In some embodiments, multiple Fibonacci spirals may be used. For example, if a graphical user interface is simulating three dimensions, then there may be a Fibonacci spiral along at least two of the three dimensions.

While FIGS. 4-6 provide examples of three visual aesthetic layouts, other visual aesthetic layouts may be used. For example, other types of Fibonacci sequences may be used, variations of the three aesthetic layouts in FIGS. 4-6 may be used, etc.

Turning to FIG. 7, in one embodiment, the visual aesthetic pattern selection may be further based on a comparison of a most recently derived usage pattern to trends defined by the plurality of usage patterns stored in usage pattern database 112. For example, if the most recently derived usage pattern is similar to trends that show that a particular visual aesthetic pattern is more likely to fit the trends, then the visual aesthetic layout associated with that particular visual aesthetic pattern is selected. Turning to FIG. 8, in one embodiment, the visual aesthetic pattern is selected from one of the rule of 3^{rd} visual aesthetic layout, the golden ratio aesthetic layout, and the Fibonacci spiral visual aesthetic layout.

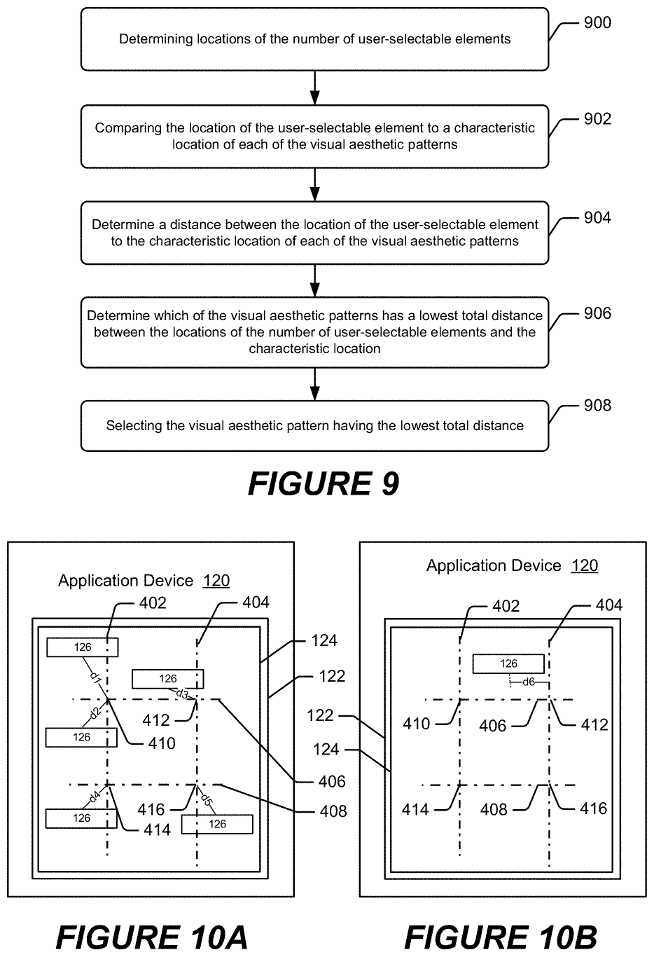

Turning to FIG. 9, if the most recently derived usage pattern is different from the trends, then the visual aesthetic pattern is selected based on the most recently derived usage pattern. At operation 900, the locations of the number of user-selectable elements are determined. For each of the number of user-selectable elements, the location of the user-selectable element 126 is compared to a characteristic location of each of the visual aesthetic patterns at operation 902. At operation 904, the distance between the location of the user-selectable element 126 to the characteristic location of each of the visual aesthetic patterns. There may be multiple characteristic locations. For example, FIGS. 10A and 10B illustrate characteristic locations of a rule of 3^{rd} visual aesthetic layout. The characteristic locations in the rule of 3^{rd} visual aesthetic layout are the lines 402-408 and the intersections of the lines 402-408. FIG. 10A illustrates the characteristic location being the locations of the intersections 410-416 of the lines 402-408. The distance between the location of the user-selectable element 126 and the characteristic locations 410-416 is illustrated as distances dl-d5 in FIG. 10A. In FIG. 10B, the characteristic location is line 404 and the distance d6 is the distance between the location of the user-selectable element 126 and the line 404. The characteristic location of the golden ratio layout is the location of the golden ratio elements a and b (see FIG. 5). The characteristic location of the Fibonacci spiral is the location of the logarithmic spiral (see FIG. 6).

At operation 906, a determination is made of which of the visual aesthetic patterns has a lowest total distance between the locations of the number of user-selectable elements and the characteristic location(s). For example, in FIG. 10A, the total distance is the sum of distances d1-d5. At operation 908, the visual aesthetic pattern having the lowest total distance is selected.

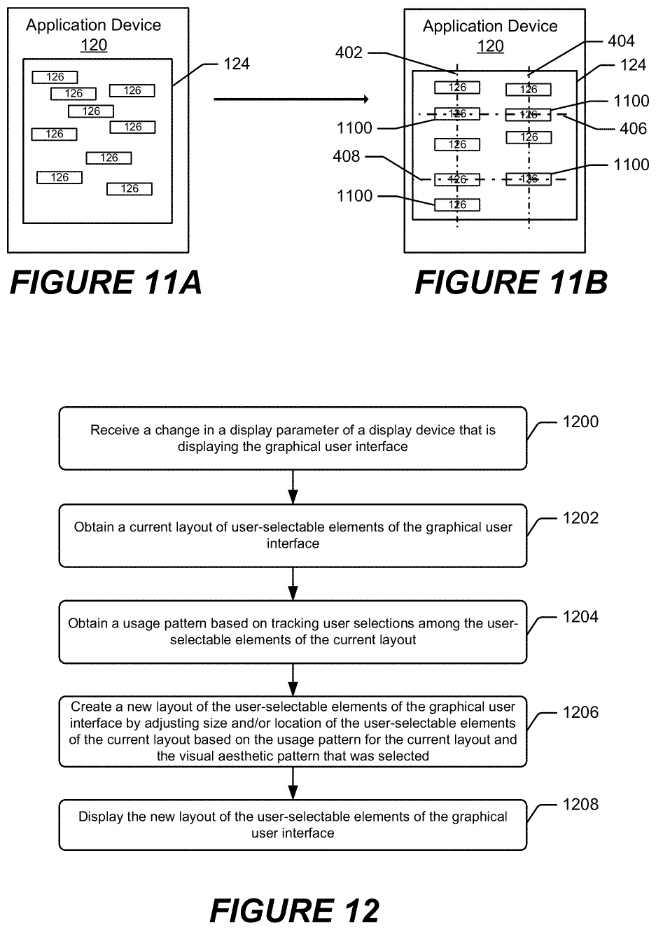

Returning to FIG. 2, at operation 210, the VA engine 102 dynamically modifies layout of the user-selectable elements 126 of graphical user interface 124 based on the selected visual aesthetic pattern. In one embodiment, the VA engine 102 transmits a message to the application 120₁ that contains instructions to direct the application 120₁ to modify the layout of the user-selectable elements 126 of graphical user interface 124 in accordance with the selected visual aesthetic pattern. At operation 212, the application device 120 displays the graphical user interface 124 with the modified layout of the user-selectable elements 126. FIG. 11A illustrates an example of a layout before modification of the layout. FIG. 11B illustrates an example of a display of a modified layout of the user-selectable elements 126 where the user-selectable elements 126 that are frequently selected are along lines 404-408 of the rule of 3^{rd} visual aesthetic layout.

The layout of the user-selectable elements 126 is dynamically modified in one embodiment when a display parameter is changed. Turning to FIG. 12, at operation 1200, an indication of a change in a display parameter of a display device (e.g., application device 120) that is displaying the graphical user interface 124 is received. The change in the display parameter may be a change in size of the user-selectable elements 126, a change in orientation of the display (e.g., portrait to landscape), a change in size of the graphical user interface 124, a change in location of the graphical user interface 124, and the like.

At operation 1202, the current layout of the user-selectable elements 126 of the graphical user interface 124 is obtained. At operation 1204, a usage pattern is obtained based on tracking user selections among the user-selectable elements of the current layout.

At operation 1206, a new layout of the user-selectable elements 126 of the graphical user interface 124 is created by adjusting, based on the usage pattern for the current layout and the visual aesthetic pattern that was selected, the size of the user-selectable elements 126, the location of the user-selectable elements 126, or the size and location of the user-selectable elements 126. At operation 1208, the new layout of the user-selectable elements 126 of the graphical user interface 124 is displayed on the display device.

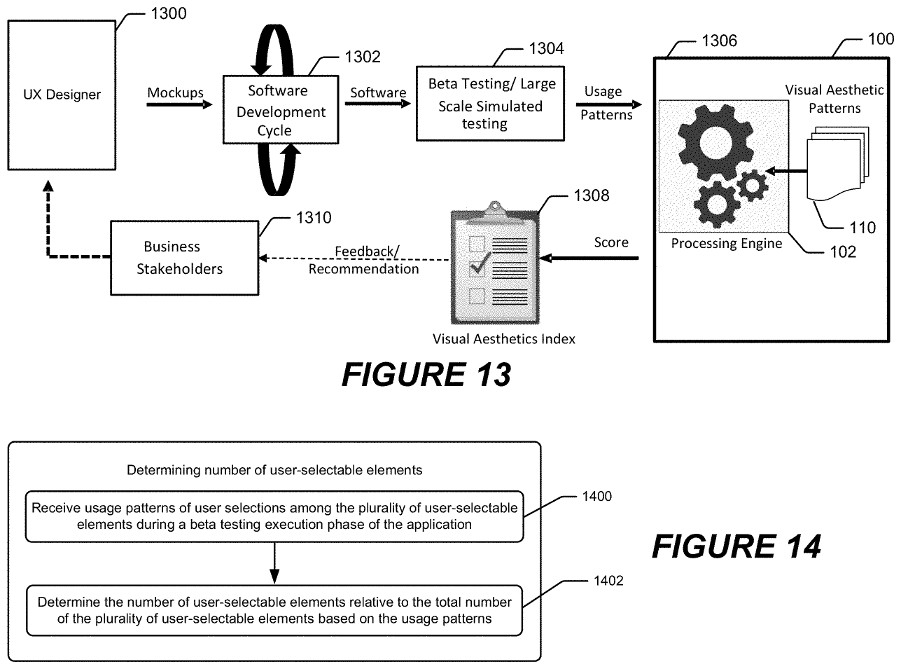

Turning now to FIG. 13, the VA engine 102 may be used during beta testing or large scale simulated testing of an application being revised or developed. At operation 1300, a graphical user interface designer during development/revision designs mockups that are used in software development cycle operations 1302. A software version of the development cycle is provided for beta testing and/or large scale simulated testing at operation 1304. Usage patterns are detected and transmitted to the VA engine 102. The usage patterns may be stored in usage pattern database 112. At operation 1306, the number of user-selectable elements is determined.

In one embodiment illustrated in FIG. 14, at operation 1400, the VA engine 102 receives usage patterns of user selections among the plurality of user-selectable elements during a beta testing execution phase of the application (e.g., operation 1304). At operation 1402, the VA engine 102 determines the number of user-selectable elements relative to the total number of the plurality of user-selectable elements based on the usage patterns. For example, the usage patterns may provide an indication of a number of user-selectable elements that are more frequently selected than other user-selectable elements.

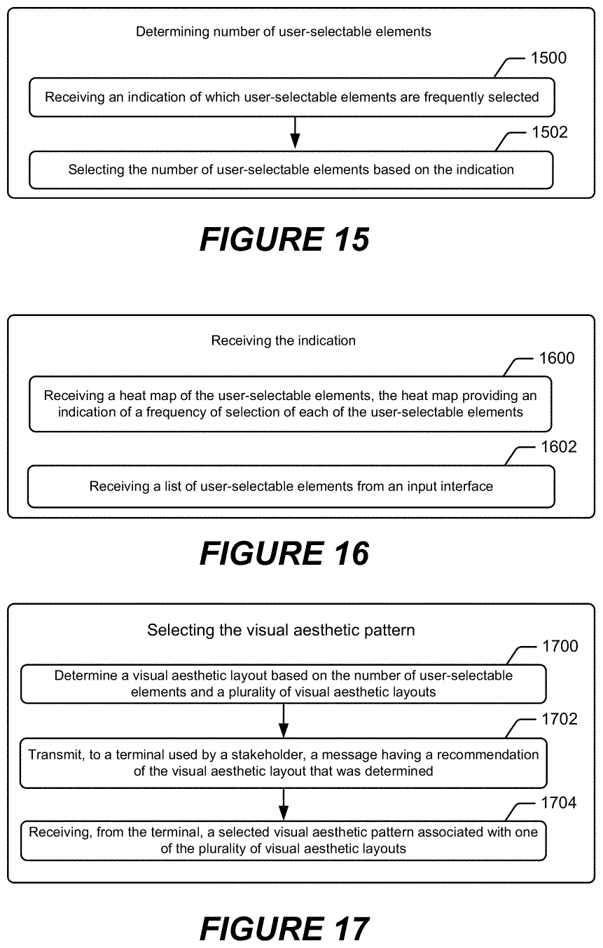

FIG. 15 illustrates another embodiment of determining the number of user-selectable elements. At operation 1500, the VA engine 102 receives an indication of which user-selectable elements are frequently selected. At operation 1502, the number of user-selectable elements is selected based on the indication. For example, a stakeholder of the software development cycle, such as a business that is purchasing software, may provide an indication of which user-selectable elements are frequently selected. Turning to FIG. 16, the indication may be in the form of a heat map, received at operation 1600, that provides an indication of a frequency of selection of each of the user-selectable elements based on the color of the heat map at each of the user-selectable elements. At operation 1602, the indication may be received by receiving a list of user-selectable elements from an input interface. For example, one of the stakeholders may provide a list of user-selectable elements that the stakeholder has determined will likely be frequently selected.

Returning to FIG. 13, at operation 1308, a score for each of the visual aesthetic layouts is determined based on the detected usage patterns. The score may be based on a comparison of the number of frequently selected user-selectable elements to the number of user-selectable elements a visual aesthetic layout can handle such that a user can easily select the user-selectable elements. In other embodiments, the score may be based on the type of user-selectable elements as some user-selectable elements may fit a particular visual aesthetic layout better than other visual aesthetic layouts. The score may also be based on the total distance between the locations of the number of user-selectable elements and the characteristic location or locations of the visual aesthetic layout.

In one embodiment, the score is a normalized score of the total distance between the locations of the number of user-selectable elements and the characteristic location or locations of the visual aesthetic layout. For example, assume the score of a first visual aesthetic layout is 45, the score of a second visual aesthetic layout is 48, the score of a third visual aesthetic layout is 60, and the score of a third visual aesthetic layout is 90. The normalized scored would then be 0.5 for the first visual aesthetic layout, 0.53 for the second visual aesthetic layout, 0.66 for the third visual aesthetic layout, and 1.00 for the fourth visual aesthetic layout. The visual aesthetic layouts having the lowest normalized scores may then be provided as a recommendation to business stakeholders at operation 1310. The business stakeholders may be the members of the design team that is responsible for the software development cycle, businesses that are partaking in the beta testing, businesses that have or will purchase the software, etc.

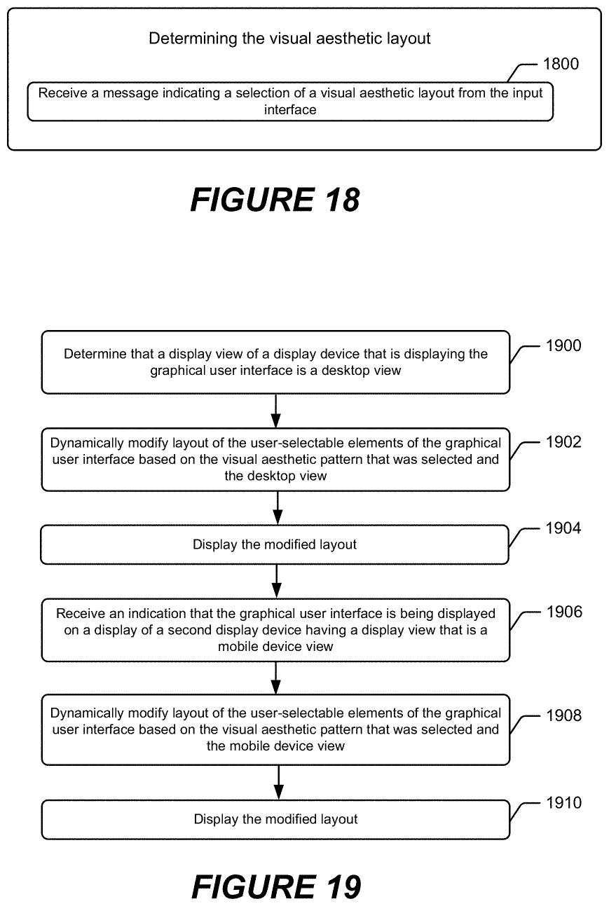

The business stakeholders select the visual aesthetic pattern that will be used in the current software development cycle. FIG. 17 is a flowchart of an embodiment of selecting the visual aesthetic pattern. At operation 1700, a visual aesthetic layout is determined based on the number of user-selectable elements and a plurality of visual aesthetic layouts. For example, the visual aesthetic layout may be determined based on the score determined in operation 1304. In another embodiment illustrated in FIG. 18, at operation 1800, the VA engine 102 receives a message indicating a selection of a visual aesthetic layout from input interface 104. The message may be transmitted by one of the stakeholders.

Returning to FIG. 17, at operation 1702, a message is transmitted by the VA engine 102 to a terminal used by a stakeholder. The message has a recommendation of the visual aesthetic layout (or layouts) that was determined. At operation 1704, the VA engine 102 receives, from the terminal used by the stakeholder, a selected visual aesthetic pattern associated with one of the plurality of visual aesthetic layouts. The selected visual aesthetic pattern may be the visual aesthetic pattern associated with the visual aesthetic layout that was recommended or it may be a different visual aesthetic pattern associated with a different visual aesthetic layout.

Turning now to FIG. 19, in some embodiments, the graphical user interface 124 may be displayed on different devices. FIG. 19 illustrates how the layout of the user-selectable elements may be dynamically modified. At operation 1900, the VA engine 102 determines that the display view of a display device (e.g., application device 120) that is displaying the graphical user interface 126 is a desktop view. At operation 1902, the VA engine 102 dynamically modifies layout of the user-selectable elements 126 of the graphical user interface 124 based on the visual aesthetic pattern that was selected and the desktop view. At operation 1904, the modified layout is displayed on the graphical user interface 124.

At operation 1906, the VA engine 102 receives an indication that the graphical user interface 126 is being displayed on a display of a second display device that has a display view that is a mobile device view. At operation 1908, the VA engine 102 dynamically modifies layout of the user-selectable elements 126 of the graphical user interface 124 based on the visual aesthetic pattern that was selected and the mobile device view. At operation 1910, the modified layout of the graphical user interface 126 is displayed on the display view of the second display device.

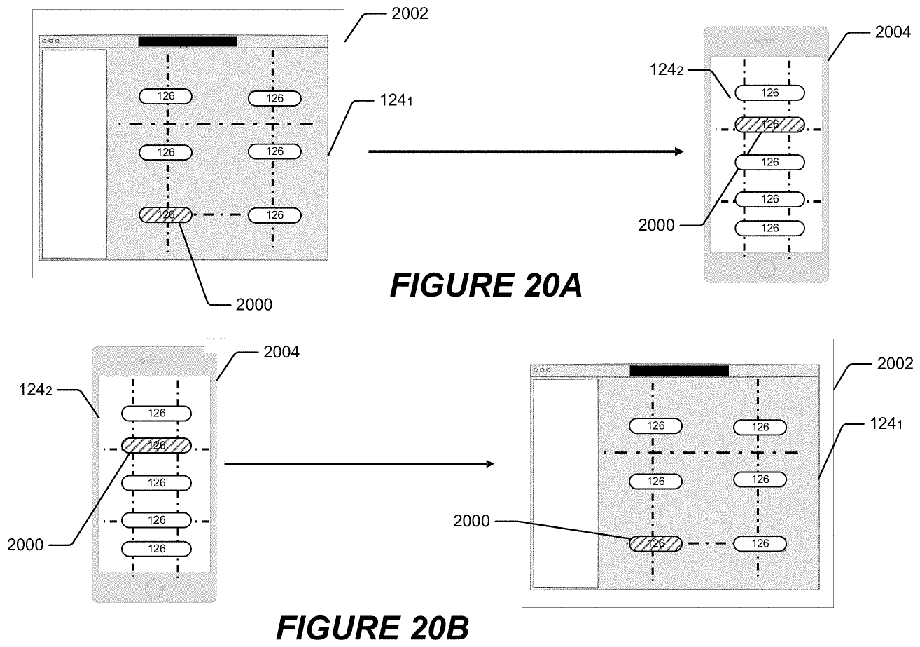

FIG. 20A provides an example of dynamically modifying the layout. In FIG. 20A, user-selectable element 2000 is displayed along a characteristic location of a rule of 3^{rd} layout of a desktop view of device 2002. When the display is changed to a mobile device 2004, the user-selectable element 2000 is moved at a different characteristic location such that the user-selectable element 2000 is fully displayed on graphical user interface 1222.

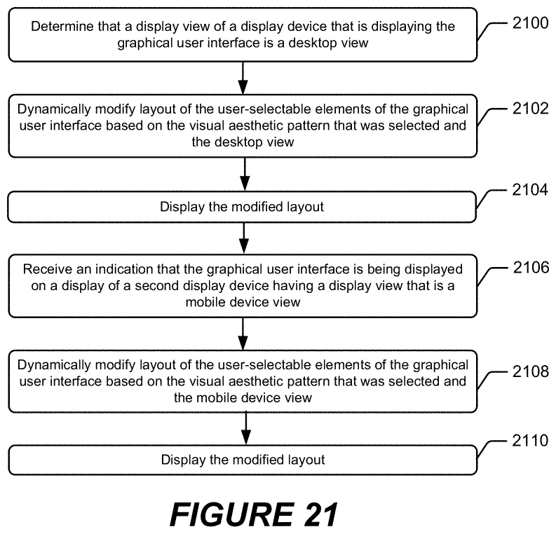

FIG. 21 illustrates how the layout of the user-selectable elements may be dynamically modified from a mobile device view to a desktop view. At operation 2100, the VA engine 102 determines that the display view of a display device (e.g., application device 120) that is displaying the graphical user interface 126 is a mobile device view. At operation 2102, the VA engine 102 dynamically modifies layout of the user-selectable elements 126 of the graphical user interface 124 based on the visual aesthetic pattern that was selected and the mobile device view. At operation 2104, the modified layout is displayed on the graphical user interface 124.

At operation 2106, the VA engine 102 receives an indication that the graphical user interface 126 is being displayed on a display of a second display device that has a display view that is a desktop view. At operation 2108, the VA engine 102 dynamically modifies layout of the user-selectable elements 126 of the graphical user interface 124 based on the visual aesthetic pattern that was selected and the mobile device view. At operation 2110, the modified layout of the graphical user interface 126 is displayed on the desktop view of the second display device.

FIG. 20B provides an example of dynamically modifying the layout from a mobile device view to a desktop view. In FIG. 20B, user-selectable element 2000 is displayed along a characteristic location of a rule of 3^{rd} layout of a mobile device view of device 2004. When the display is changed to a device 2002 having a desktop view, the user-selectable element 2000 is moved at a different characteristic location such that the user-selectable element 2000 is fully displayed on graphical user interface 1221.

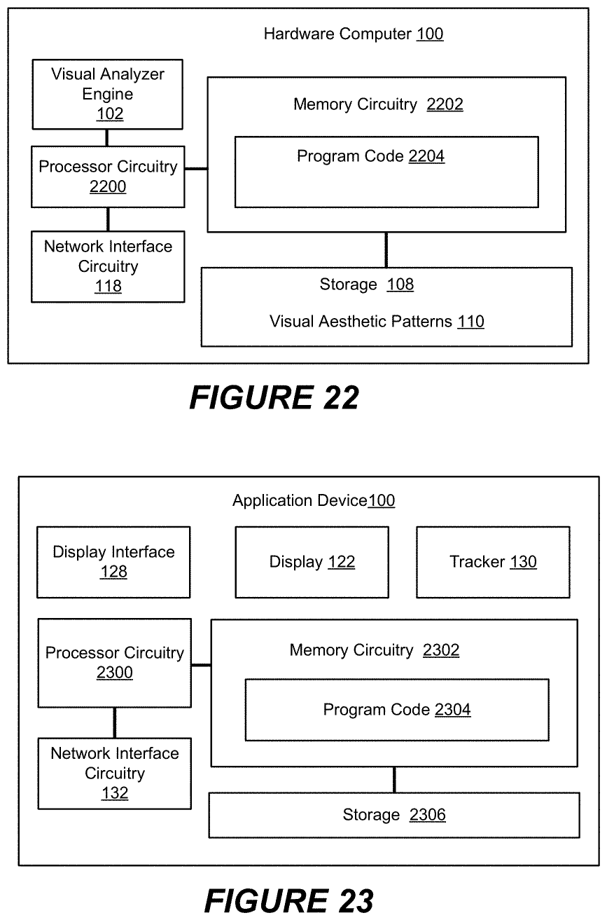

FIG. 22 provides an overview diagram of a suitable computer hardware and computing environment in conjunction with which various embodiments of the VA engine 102 may be practiced. The description of FIG. 23 is intended to provide a brief, general description in conjunction with which the subject matter described herein may be implemented that provides improvements in the computer functionality of applications by dynamically modifying layout of user-selectable elements of a GUI of applications during runtime without having to update the applications. In some embodiments, the subject matter is described in the general context of computer-executable instructions, such as program modules, being executed by a computer, such as a personal computer that provide the improvements described above. Generally, program modules include routines, programs, objects, components, data structures, and the like, that perform particular functions described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 22, a hardware and operating environment 100 is provided that is applicable to the VA engine 102 shown in the other figures. As shown in FIG. 22, one embodiment of the hardware and operating environment 100 includes processing circuitry 2200 having one or more processing units coupled to the network interface circuitry 118 and a memory circuitry 2202. The memory circuitry 2202 may include a ROM, e.g., a flash ROM, a RAM, e.g., a DRAM or SRAM, or the like and includes suitably configured program code 2204 to be executed by the processing circuitry so as to implement the above described functionalities of the VA engine 102. The storage 108 may include a mass storage, e.g., a hard disk or solid-state disk, or the like. The storage 108 may store visual aesthetic pattern information 110. There may be only one or more than one processing unit, such that the processor circuitry 2200 comprises a single central-processing unit (CPU), or a plurality of processing units, commonly referred to as a multiprocessor or parallel-processor environment. A multiprocessor system can include cloud computing environments. In the illustration shown, the VA engine 102 is part of hardware computer 100. In alternate embodiments, the VA engine 102 is a stand-alone device that has the processor circuity 2200, the network interface circuity 118, the memory circuitry 2202 having program code 2204, storage 108, and visual aesthetic pattern information 110.

FIG. 23 provides an overview diagram of a suitable computer hardware and computing environment in conjunction with which various embodiments of monitoring system 102 may be practiced. The description of FIG. 23 is intended to provide a brief, general description in conjunction with which the subject matter may be implemented. In some embodiments, the invention is described in the general context of computer-executable instructions, such as program modules, being executed by a computer, such as a personal computer. Generally, program modules include routines, programs, objects, components, data structures, and the like, that perform particular tasks or implement particular abstract data types.

In the embodiment shown in FIG. 23, a hardware and operating environment is provided that is applicable to the application device 120 described in the other figures and described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 23, a hardware and operating environment is provided that is applicable to the application device 120 shown in the other figures. As shown in FIG. 23, one embodiment of the hardware and operating environment includes processing circuitry 2300 having one or more processing units coupled to the network interface circuitry 132 and a memory circuitry 2302. The memory circuitry 2302 may include a ROM, e.g., a flash ROM, a RAM, e.g., a DRAM or SRAM, or the like and includes suitably configured program code 2304 to be executed by the processing circuitry so as to implement that above described functionalities of the application device 120. The storage 2306 may include a mass storage, e.g., a hard disk or solid-state disk, or the like. There may be only one or more than one processing unit, such that the processor circuitry 2300 of application device 120 comprises a single central-processing unit (CPU), or a plurality of processing units, commonly referred to as a multiprocessor or parallel-processor environment. A multiprocessor system can include cloud computing environments.

Thus, example systems, methods, and non-transitory machine readable media for controlling monitoring systems to stop and start monitoring have been described. The advantages provided include dynamically modifying layout of user-selectable elements of a GUI of an application during runtime without having to update the application. The layout can be modified based on a change in display view, a change in one or more display parameters, a change in the device that is running the application, usage patterns determined over periods of time, user input, user feedback, and the like. The advantages further allow the layout to be dynamically modified based on changing styles over time based on the usage patterns and user feedback without requiring the application to be updated. This results in reduced cost of application development and a better user experience, which can lead to increased use of an application compared to other applications that have fixed layouts that cannot be changed between application updates.

As will be appreciated by one of skill in the art, the present inventive concepts may be embodied as a method, data processing system, or computer program product. Furthermore, the present inventive concepts may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

Some embodiments are described herein with reference to flowchart illustrations or block diagrams of methods, systems and computer program products. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations described herein may be written in an object-oriented programming language such as Java® or C++. However, the computer program code for carrying out operations described herein may also be written in conventional procedural programming languages, such as the “C” programming language. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A method by a computer of dynamically modifying layout of a graphical user interface of an application, the graphical user interface having a plurality of user-selectable elements, the method comprising:
determining a number of user-selectable elements relative to a total number of the plurality of user-selectable elements that are selected more frequently than other user-selectable elements based on tracking user selections among the user-selectable elements over a period of time;
selecting a visual aesthetic pattern from among a set of visual aesthetic patterns based on the number of user-selectable elements;
dynamically modifying layout, during runtime of the application, of the user-selectable elements of the graphical user interface based on the visual aesthetic pattern that was selected; and
displaying the graphical user interface with the modified layout of the user-selectable elements of the graphical user interface.

2. The method of claim 1 wherein determining the number of user-selectable elements comprises
determining usage pattern based on the tracking of user selections of the user-selectable elements over the period of time; and
determining the number of user-selectable elements based on the usage pattern.

3. The method of claim 2 further comprising:
storing the usage pattern in a usage pattern database, wherein the usage pattern database stores a plurality of usage patterns; and
wherein selecting the visual aesthetic pattern is further based on a comparison of a most recently derived usage pattern to trends defined by the plurality of usage patterns.

4. The method of claim 1 further comprising:
receiving a change in a display parameter of a display device that is displaying the graphical user interface;
obtaining a current layout of user-selectable elements of the graphical user interface;
obtaining a usage pattern based on tracking user selections among the user-selectable elements of the current layout;
creating a new layout of the user-selectable elements of the graphical user interface by adjusting size and/or location of the user-selectable elements of the current layout based on the usage pattern for the current layout and the visual aesthetic pattern that was selected; and
displaying the new layout of the user-selectable elements of the graphical user interface.

5. The method of claim 4 wherein receiving the change in the display parameter comprises receiving one of a change in display orientation or a change in display resolution size.

6. The method of claim 1 wherein selecting a visual aesthetic pattern from among the set of visual aesthetic patterns comprises:
determining locations of the number of user-selectable elements;
for each of the number of user-selectable elements:
comparing the location of the user-selectable element to a characteristic location of each of the visual aesthetic patterns;
determine a distance between the location of the user-selectable element to the characteristic location of each of the visual aesthetic patterns;
determine which of the visual aesthetic patterns has a lowest total distance between the locations of the number of user-selectable elements and the characteristic location; and
selecting the visual aesthetic pattern having the lowest total distance.

7. The method of claim 1 wherein selecting a visual aesthetic pattern from among the set of visual aesthetic patterns comprises selecting the visual aesthetic pattern from one of: a rule of 3^{rd} visual aesthetic layout, a golden ratio visual aesthetic layout, and a Fibonacci spiral visual aesthetic layout.

8. The method of claim 1 wherein determining a number of user-selectable elements relative to a total number of the plurality of user-selectable elements that are selected more frequently than other user-selectable elements comprises:
receiving usage patterns of user selections among the plurality of user-selectable elements during a beta testing execution phase of the application; and
determining the number of user-selectable elements relative to the total number of the plurality of user-selectable elements based on the usage patterns.

9. A visual analyzer (VA) engine of a networked hardware computer, the VA engine comprising:
a processor and a memory coupled to the processor, wherein the memory stores computer program instructions that are executed by the processor to perform operations comprising:
determining a usage pattern of a plurality of user-selectable elements of a graphical user interface of an application;
determining a number of user-selectable elements relative to a total number of the plurality of user-selectable elements that are selected more frequently than other user-selectable elements based on the usage patterns;
selecting a visual aesthetic pattern from among a set of visual aesthetic patterns based on the number of user-selectable elements;
dynamically modifying layout, during runtime of the application, of the user-selectable elements of the graphical user interface based on the visual aesthetic pattern that was selected; and
displaying the graphical user interface with the modified layout of the user-selectable elements of the graphical user interface.

10. The VA engine of claim 9, wherein determining the usage pattern comprises:
receiving an indication of which user-selectable elements are frequently selected; and
selecting the number of the user-selectable elements based on the indication.

11. The VA engine of claim 10, wherein receiving an indication of which user-selectable elements are frequently selected comprises receiving a heat map of the user-selectable elements, the heat map providing an indication of a frequency of selection of each of the user-selectable elements.

12. The VA engine of claim 10, wherein receiving the indication of which user-selectable elements are frequently selected comprises receiving a list of user-selectable elements from an input interface.

13. The VA engine of claim 9, wherein selecting a visual aesthetic pattern based on the number of user-selectable elements comprises receiving an indication of a selection of a visual aesthetic pattern from the input interface.

14. The VA engine of claim 9 wherein selecting the visual aesthetic pattern comprises:
determining a visual aesthetic pattern based on the number of user-selectable elements;
transmit, to a terminal used by a designer, a message having a recommendation of the visual aesthetic pattern that was determined; and
receiving, from the terminal, a selected visual aesthetic pattern.

15. The VA engine of claim 9, wherein the operations further comprise:
receiving a change in a display parameter of a display device that is displaying the graphical user interface;
obtain a current layout of the user-selectable elements of the graphical user interface;
obtain a usage pattern based on tracking user selections among the user-selectable elements of the current layout;
creating a new layout of the user-selectable elements of the graphical user interface by adjusting size and/or location of the user-selectable elements of the current layout based on the usage pattern for the current layout and the visual aesthetic pattern that was selected; and
displaying the new layout of the user-selectable elements of the graphical user interface.

16. The VA engine of claim 9, wherein the operations further comprise:
determining that a display view of a display device that is displaying the graphical user interface is a desktop view;
dynamically modifying layout of the user-selectable elements of the graphical user interface based on the visual aesthetic pattern that was selected and the desktop view;
receiving an indication that the graphical user interface is being displayed on a display of a second display device having a second display view that is a mobile device view; and
dynamically modifying layout of the user-selectable elements of the graphical user interface based on the visual aesthetic pattern that was selected and the mobile device view.

17. The VA engine of claim 9 wherein the operations further comprise:
determining that a display view of a display device that is displaying the graphical user interface is a mobile device view;
dynamically modifying layout of the user-selectable elements of the graphical user interface based on the visual aesthetic pattern that was selected and the mobile device view;
receiving an indication that the graphical user interface is being displayed on a display of a second display device having a second display view that is a desktop view; and
dynamically modifying layout of the user-selectable elements of the graphical user interface based on the visual aesthetic pattern that was selected and the desktop view.

18. The VA engine of claim 9, wherein selecting a visual aesthetic pattern comprises:
determining locations of the number of user-selectable elements;
for each of the number of user-selectable elements:
comparing the location of the user-selectable element to a characteristic location of each of the visual aesthetic patterns;
determine a distance between the location of the user-selectable element to the characteristic location of each of the visual aesthetic patterns; and
scoring each of the visual aesthetic patterns;
determining an overall score of each of the visual aesthetic patterns based on the scoring for each of the number of user-selectable elements; and
selecting the visual aesthetic pattern based on the overall score of each of the visual aesthetic patterns.

19. The VA engine of claim 9, wherein the number of user-selectable elements is a pre-determined number.

20. The VA engine of claim 9, wherein the number of user-selectable elements is based on a maximum number of user-selectable elements that can be processed by the visual aesthetic patterns.
